(19) United States
(12) Patent Application Publication
(10) Pub. No.: US 2018/0142630 A1
(43) Pub. Date: May 24, 2018

(54) Diesel Electric Generator Load Bank System Cooled by Exhaust Gas and Method Therefor

(71) Applicant: Richard Boggs, Fort Lauderdale, FL (US)

(72) Inventor: Richard Boggs, Fort Lauderdale, FL (US)

(21) Appl. No.: 15/356,775

(22) Filed: Nov. 21, 2016

(51) Int. Cl. F02D 29/06; F01P 7/02; F02B 63/04; F02D 41/02; F01N 5/02; H02K 7/18; H01C 1/082; H01C 10/16

(52) U.S. Cl. CPC F02D 29/06; F01P 7/026; F02B 63/042; F02D 41/0245; F02D 2041/026; H02K 7/1815; H01C 1/082; H01C 10/16; F01P 2060/185; F01N 5/02

(57) ABSTRACT

A 3-phase driven resistor load bank, electrically connected to an engine-generator-set is controlled to maintain a minimum generator load by turning ON and OFF load-bank heaters for optimal operation of the engine. An operator selects KW power output that best meets electrical load conditions and the load bank converts surplus electrical energy to heat, then cooled by the exhaust gas. The exhaust-gas-cooled resistive heater load bank, mounted in gas flow path, provides a dummy load to the gen-set which allows gen-set to operate at operator defined load level to enhance engine performance and reduce maintenance costs. The gas flow cools the inline resistive heater elements. The 3-phase AC power to the resistor load bank is only switched ON/OFF at zero-crossing points to eliminate electrical noise.

The present invention relates to a system and a method wherein a load bank comprised of multiple load resistors is electrically connected to an engine-generator set (engine-gen set) and the resistive load bank is cooled by diesel engine exhaust (the diesel engine driving a generator) thereby maintaining a minimum generator load for optimal operation of the diesel engine-generator set (achieved by the load bank converting “surplus” electrical energy to heat cooled by the engine-gen set exhaust gas).

### TECHNICAL FIELD

The disclosed embodiments relate generally to systems of diesel engine-generators with controlled load banks cooled by exhaust gas.

### BACKGROUND

Diesel powered electric generators frequently operate at load conditions which are below that required to obtain optimal combustion conditions. Long term operation under low loading conditions leads to increased wear of cylinder liners, poor compression, increased lubricating oil consumption and greatly increased exhaust emissions.

Experienced practitioners of the art know that maintaining diesel-generator set loading between around 50 percent and 75 percent or greater of rated electrical load leads to reduced maintenance and lower life cycle costs. The problem with many generator installations is that wide variations in electrical loads often lead to extended periods of low load operation on the diesel engine, thereby causing problems with the diesel. For example, at low load, the diesel operates at low temperatures and low pressures that cause leakage between the piston head and the cylinder, resulting in wet stacking, release of uncombusted fuel, higher particulate matter released through the exhaust and piston glaze. All this results in a higher rate of wear on the engine.

Typically the solution to chronic underloading is to connect an electric load bank or “dummy load” to the generator output. Typically, this is added dummy electric load bank is a set of resistors completely remote from all elements of the engine-gen set. This technique increases electrical load to a level at which optimum diesel engine performance is obtained. The heaters in prior art systems are somewhere on-board the vessel, sometimes in the engine room and at other times remote from the engine room. Heat produced by these remotely operated resistive load banks must be quickly dissipated for personnel safety and proper load bank operation.

In marine applications, the use of a resistive load bank creates several related problems. First, all resistive load banks produce heat as a byproduct. This generated heat can be a serious issue in a closed, engine room space in a marine vessel.

In terrestrial or land-based applications, forced air cooling is the normal method means to dissipate the heat produced by the “resistive dummy load bank” of electrical resistance elements which provide the added load to properly load the diesel in the engine-generator set. An electrically powered fan moves cool air across the resistor load bank and transfers heat to the atmosphere.

Air cooling is rarely an option for marine vessels due to limitations of space, a generally corrosive atmosphere (especially true in salt water applications), and the noise created by fans required to move the large volume of air needed to cool the resistor load bank is unacceptable on pleasure yachts. Water cooling is the method utilized by currently available marine resistive load banks. A water cooled resistive load bank requires a hull penetration and isolation valve to supply seawater to a circulation pump. The discharge of the circulation pump is routed to a vessel in which resistance elements may be fitted for direct contact with seawater, or to a heat exchanger that allows heat from a secondary cooling fluid (typically a mixture of fresh water and corrosion inhibitors) in contact with the elements to conduct through metallic plates or tubing to the seawater which is then discharged back to the sea through another valve and hull penetration. Heat removed in this manner is truly waste heat and performs no useful work on the vessel. Resistive load banks which use seawater as a direct coolant expose the resistance elements to highly corrosive chlorides with the result that maintenance on such systems is very high and element life is quite short. Systems which use a secondary fluid require the use of a second circulation pump and associated valves and controls. In short, liquid cooling of generator load banks transfers maintenance costs and time from the diesel generator to the load bank.

At low temperatures and low pressures, the diesel engine cylinder heads cause leakage releasing gas and uncombusted fuel. Sometimes this is called wet stacking. Further a piston glaze may build up on the cylinders which causes a high degree of wear.

### OBJECTS OF THE INVENTION

It is an object of the present invention to provide a system and a method wherein a load bank of multiple load resistors is electrically connected to an engine-generator set and the resistive load bank is cooled by diesel engine exhaust (the diesel engine driving a generator) thereby maintaining a minimum generator load for optimal operation of the diesel engine-generator set (achieved by the load bank converting “surplus” electrical energy to heat which heat is dissipated by the cooler engine exhaust gas).

It is another object of the present invention to provide a method by which the power delivered to the heaters causes the engine-generator set (gen-set) to operate at a higher level (to supply the needed electrical power to the then turned ON load resistive heat bank) at a level above the exhaust gas temperature and concurrently, to use the engine exhaust gas flow to cool the then turned ON heaters. This process is counter-intuitive since the load resistive heat bank is ON and yet the exhaust gas cools the load resistive heat bank as the gas passes over the load bank The power supplied by the gen-set to the load resistive heat bank is varied in proportion to the temperature of the exhaust gases entering the system.

### SUMMARY

The method of cooling load bank resistive elements with exhaust gas from a diesel engine electric generator set is deployed in connection with an electric generator which generates three phase AC power. A diesel engine drives an electric generator as a gen-set. Exhaust gas flow is ported from the diesel engine to an exterior environment. A number of resistive heater load elements are placed in the exhaust gas flow before the gas is ported or expelled into the environment. The process monitors exhaust gas temperature in the exhaust gas flow after the plurality of resistive heater load elements. The electrical load is increased on the gen-set by activating ON the plurality of resistive heater load elements by three phase AC power applied thereto from the electric generator, thereby adding heat to the exhaust gas flow before expelling the gas into the environment. The plurality of resistive heater load elements are turned ON and OFF substantially only at zero-crossing times for the three phase AC power applied thereto, thereby substantially eliminating electrical interference noise from switching ON and OFF the plurality of resistive heater load elements. AS a result, the plurality of resistive heater load elements are cooled with the exhaust gas flow from the diesel engine while maintaining a preprogrammed setpoint for the operation of the gen-set.

The method also includes the use of at least three resistance load elements, each supplied with a distinct phase of the three phase AC power, and each switched ON and OFF. The plurality of resistance load elements are a plurality of load step resistors. Further the method may include remotely controlling and changing the setpoint for the operation of the gen-set. The term “remote” meaning a distance away and apart from the engine room where the gen-set operates. The engine exhaust gas is ported away from the engine room.

Further, the method may include increasing, in a step-wise manner, the electrical load on the gen-set by activating ON one or more of the plurality of resistive heater load elements at substantially the zero-crossing of the three phase AC power over a predetermined number of three phase AC power cycles and turning OFF the one or more of the plurality of resistive heater load elements at another predetermined number of three phase AC power cycles while substantially maintaining the preprogrammed setpoint for the operation of the gen-set. The realtime operating parameters are displayed for the gen-set and electrical output as is the exhaust gas temperature. This data is stored in memory for later retrieval.

As a system, the diesel engine driven electric generator operates with a load bank which load bank is cooled by exhaust gas. The diesel engine drives an electric generator as a gen-set. The electric generator generates three phase AC power. An exhaust pipe from the diesel engine ports exhaust gas and exhaust gas flow to an exterior environment, beyond the engine room to a point out side the vessel or the gen-set containment structure. A plurality of resistive heater load elements are disposed in the exhaust pipe's exhaust gas flow before porting the exhaust gas into the environment. The plurality of resistive heater load elements are supplied with the three phase AC power from the electrical generator and are turned ON and OFF substantially at the zero-crossing of the three phase AC power such that electrical interference noise from switching ON and OFF the plurality of resistive heater load elements is substantially eliminated. An exhaust gas temperature sensor is disposed in the exhaust pipe, after the heaters to monitor exhaust gas flow temperature downstream of the plurality of resistive load elements but before porting the gas into the environment. A controller operatively maintains a preprogrammed power output setpoint for the operation of the gen-set. The controller is coupled to the plurality of resistive load elements and to the exhaust gas temperature sensor. The controller increases the electrical load on the gen-set by activating ON one or more of the plurality of resistive load elements, thereby adding heat to the exhaust gas flow before porting the exhaust gas into the environment. As a result, the plurality of resistive load elements are cooled by exhaust gas flow from the diesel engine.

The system may use load step resistors. The controller is preferably a local controller for the plurality of resistive load elements, and the system may includes a remote controller for changing the setpoint for the operation of the gen-set. The system may also include a memory unit, coupled to the controller which for storing data representing operating parameters for the gen-set, electrical output and the sensed exhaust gas temperature. The system may also include a display for displaying realtime operating parameters for the gen-set and the electrical output and the sensed exhaust gas temperature.

The load bank includes multiple load resistors is electrically connected to an engine-generator set and a control system maintains a minimum generator load by turning ON and OFF the heaters when necessary for optimal operation of the diesel engine driving the generator. The control system permits the operator to select a generator output typically a (KW output set point) that best meets electrical load conditions. The load bank converts “surplus” electrical energy to heat which may then be used to ensure efficient DPF regeneration.

The exhaust gas cooled resistive heater load bank is mounted in the exhaust gas flow path from the diesel engine, that provides a dummy load to an electric generator in the engine-generator set, which allows an engine-generator to operate at an operator defined load level to enhance diesel engine performance and reduce maintenance costs. The exhaust gas flow cools the inline resistive heater elements.

A control system which monitors active power produced by the generator and controllably adds one or several elements of a plurality of resistive heater elements which are all connected to the generator output through solid state switches to provide load step switching in less than 0.0002 seconds (<200 microseconds) in response to varying distributed loads. The resistive heater elements are mounted in the exhaust gas flow path of the diesel engine. The number of heater resistive load elements is selected to provide the smallest practical step for the generator and load conditions typical of the electrical distribution system in which it is fitted so as to provide the smoothest possible load changes and avoid electrical noise and spikes associated with mechanical contactors.

The control system embodies a control panel which permits an operator to select a desired added generator load which is then automatically managed by the power controller. The heater resistive elements are controlled by the power controller. The controller incorporates a data logger which records load level, time, and date at operator selected intervals and displays historical data and a trend monitor as well as displaying either on command or always ON, instantaneous conditions. The control system is configured with a “fail safe” device in that failure of the load elements or controller will not disable the generator or other connected loads. The fail safe sub-system is a temperature limit module that turns OFF the resistive heaters when the Temp limit is exceeded. This feature is particularly critical in marine installations.

The load bank controller may be configured to allow the operator to select automatic operation (load matches operator KW setpoint), manual (full resistance element capacity online, ON without variable control at the control set point) or OFF (system disconnected-disabled) at any time.

The load bank controller may be connected by wireless or wired data paths to the distribution system switchboard for display of load bank parameters locally or for retransmission to local or remote networks such as the “Internet Of Things.” The load bank controller may be linked via a communications network to a laptop computer or other computer-based device.

The controller incorporates a temperature safety limiter to protect the exhaust piping and resistance elements from excessive temperature increases which might result from downstream exhaust system conditions. Operation of the safety limiter instantly removes all electrical power from the resistance elements.

The controller includes an operator selectable priority control to enable operation of the system to use exhaust gas temperature as the controlling process for generator active load when electrical loading is determined to be most critical.

### BRIEF DESCRIPTION OF THE DRAWINGS

FIG. 1 diagrammatically illustrates a block diagram of functional modules for the diesel electric generator load bank system cooled by exhaust gas.

FIG. 2 diagrammatically illustrates a functional process flow chart showing the processes for the diesel electric generator load bank system cooled by exhaust gas method.

FIG. 3 diagrammatically illustrates an example of the user or system operator interface for the load bank controller (the user interface may be built-in as an integrated module with the load bank controller or may be a separate unit electrically coupled to the bank controller).

FIG. 4 diagrammatically shows switching at the zero-crossing of the heater-resistors.

### DETAILED DESCRIPTION OF THE PREFERRED EMBODIMENTS

The present invention relates to a system and a method wherein a load bank comprised of multiple load resistors is electrically connected to an engine-generator set and the resistive load bank is cooled by diesel engine exhaust (the diesel engine driving a generator) thereby maintaining a minimum generator load for optimal operation of the diesel engine-generator set (achieved by the load bank converting “surplus” electrical energy to heat to ensure efficient diesel operation). In the drawings, and sometimes in the specification, reference is made to certain abbreviations. The Abbreviations Table near the end of the specification provides a correspondence between the abbreviations and the item or feature. Similar numerals designate similar items throughout the drawings.

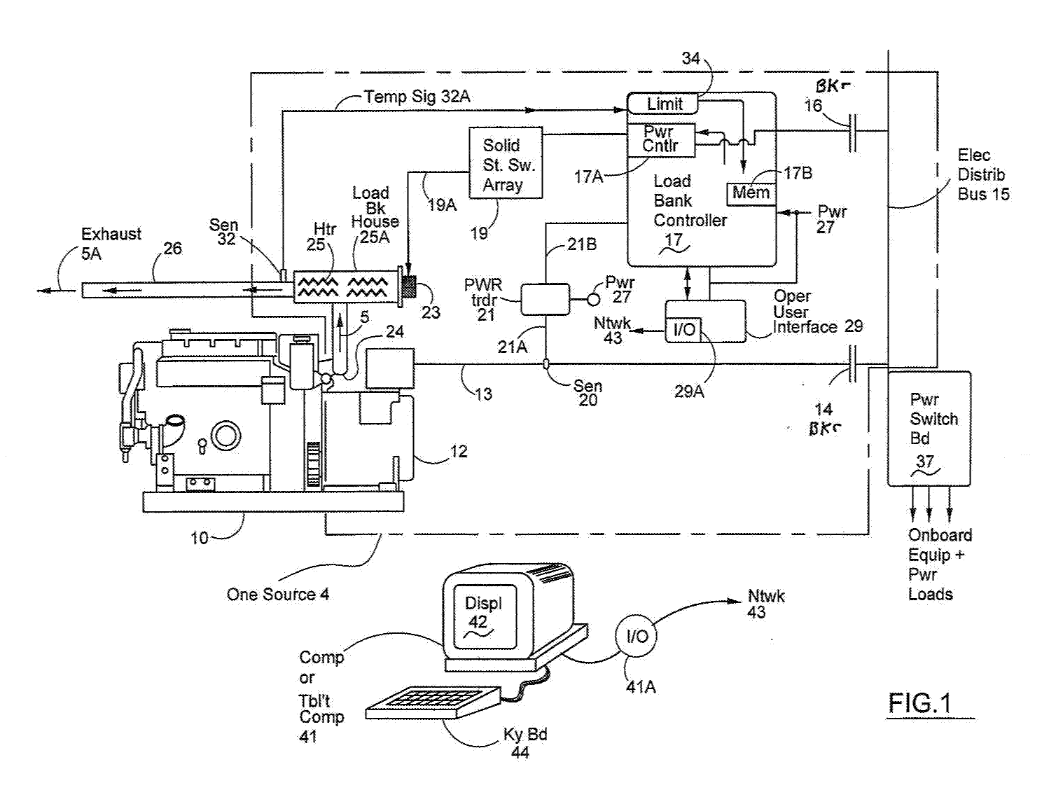

FIG. 1 depicts an engine-generator 10, 12 (a gen-set) and load bank system comprising a diesel engine 10 mechanically connected to drive an alternator 12. Other than a diesel engine, any internal combustion engine may be loaded and controlled by this system. Three phase electrical power from the gen-set comes from the electrical generator.

The electrical output of the alternator/electrical generator 12, is connected to an output bus 13, which is connected to the electrical distribution bus 15, through the generator breaker 14. High voltage to the load bank controller 17 is supplied though load bank breaker 16 to power controller 17A which ultimately feed 3 phase AC power to solid state switch array 19.

The electrical alternator 12 is a 3 phase generator an maybe sized and configured for a range of voltages and frequencies. In most European built marine installations, for example, the generator is configured to produce 400 volt AC 3-phase power at 50 Hz.

The alternator 12 is equipped with an automatic voltage regulator to control output voltage and the diesel engine 10 is equipped with a governor control system to maintain constant frequency.

A current transducer 20 or a plurality of current transducer sensors 20 is fitted on the alternator output bus 13 between the alternator 12 and the generator breaker 14. Transducer sensor 20 senses the flow of power from the alternator 12 to provide a voltage or current signal proportional to the alternator output to a power transducer module 21. Line 21A carries a current i and/or a voltage v representative signal proportional to the flow of power on output bus 13. Power transducer module 21 converts the signal into a signal compatible with the load bank controller system 17. For example, a low voltage control signal.

The power transducer 21 produces an output signal proportional to the active power delivered to the electrical distribution system bus 15. The active power signal is supplied to the load bank power controller 17.

The heater resistive load bank power controller 17 enclosure contains a plurality of solid state switches 19 (shown as a different functional module in FIG. 1) but the array 19 may be enclosed in the box about the load bank controller 17. The array controls the flow of 3-phase power on line 19A to resistance element terminal posts 23 coupled to a plurality of resistance heater elements 25 fitted within the load bank housing 25A. Preferably, three resistance heater elements 25 (for example R1, R2, R3) are each supplied with a distinct phase of the 3-phase AC power (for example, R! is fed phase 1; R2 is fed phase 2 and R3 is fed phase 3). The number of switches and resistance elements varies with the maximum load required for a specific installation and, in the preferred embodiment, load steps of less than 5 kW are considered ideal for smooth load control across the system range.

The resistive heater elements are operated in a 3 phase configuration. In a preferred embodiment, there are a minimum of 3 load resistive elements 25 in order to have load steps of less than 5 kW.

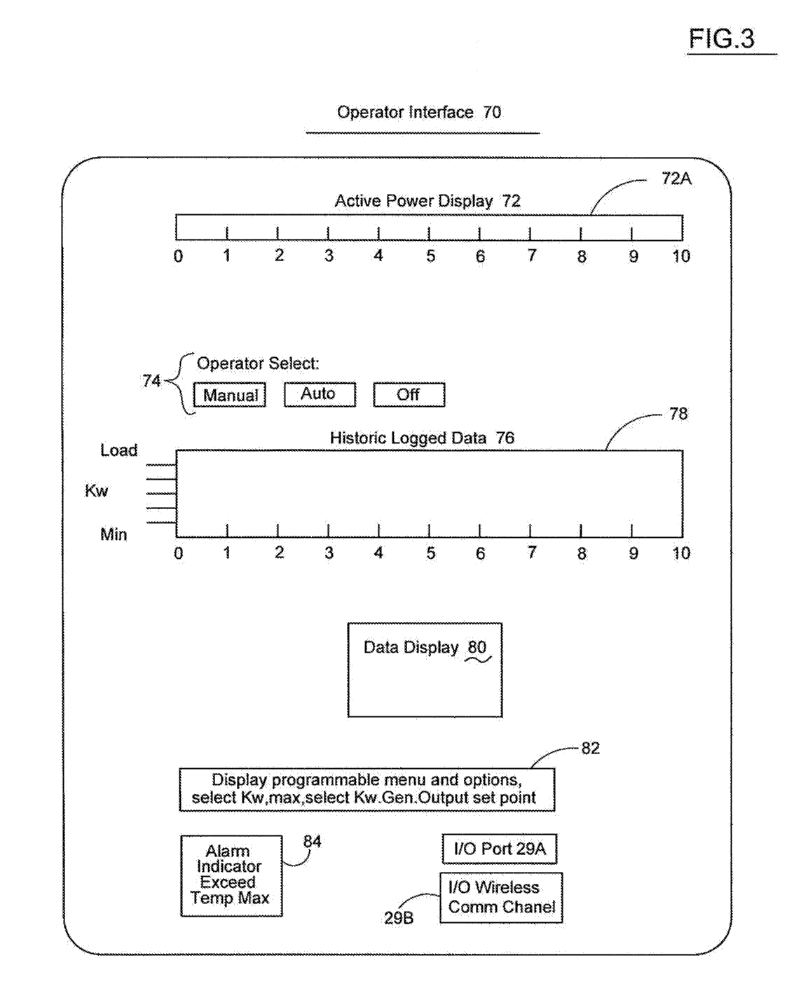

An operator interface 29 provides a display (see FIG. 3) of operating parameters which include active power, load bank setpoint, selection of automatic, manual, or off power management options, and display of logged data.

Low voltage direct current power line 27 supplies low voltage power the operator interface 29 and load bank controller 17 and may be supplied from the alternator local control panel 37 or the diesel engine DC supply. 3-Phase power to power controller 17A is supplied via bus 15 and breaker 16.

The load bank resistance element housing 25A and, more precisely, the load bank resistive heaters, are placed in the diesel engine exhaust flow 5 between the engine exhaust manifold 24 and the exhaust piping 26 leading to an exhaust port and then to the ambient environment or atmosphere. Post heated exhaust flow gas 5A is ultimately piped out of the vessel or land-based unit vi ana exhaust port.

Exhaust gas temperature leaving the resistance element housing 15 is measured by a downstream thermocouple sensor 32 inserted into the exhaust gas flow or otherwise configured to measure gas temperature. The temperature signal 32A is supplied to the load bank controller 17.

In one embodiment, thermocouple output voltage 32A is connected to the load bank controller 17 as a system over-temperature safety limit input. The temperature signal is supplied to limit module 34 which issues an alarm when the temperature exceeds a predetermined level.

In an alternate embodiment, thermocouple output voltage 32A is connected to the load bank controller as a general exhaust gas temperature signal.

The system, shown in dash-dot-dash lines, is a one source electrical system 4. Stated otherwise, a second engine-gen set can be subject to load bank control in a similar manner as discussed herein with engine 10 in one source system 4.

The load controller 17 may be integral with solid state switch array 19. One array 19 uses solid state relays, model AD-SSR625-DC-480A made by Automation Direct. Controller 17 has a power controller module 17a which feeds the power-based control signals to the switch array 19. The Operator User Interface 29 may also be integral with load bank controller 17 or it may be located in a separate housing. An input-output 29A sends and receives communication signals over network 43 (a LAN, a wireless or a BlueTooth (tm) communications network).

A computer-based remote control and user interface is provided by computer 41. Display 42 and keyboard 44 enables a user to remotely control load bank controller 17 via user interface 29, input-output 29A, and input-output module 41A (typically module 41A is integrated into the computer 41). Independently, the user interface 29 can directly control load bank controller 17 via a user interface 29.

It is commonly known that gen-set power on line 13 is fed to a power switch board 37 which, in turn, is coupled to onboard equipment and power loads.

High voltage electrical power from the power controller 17A is supplied to the solid state switch array 19 through load bank controller 17 via breaker 16.

Low voltage DC control power from power point 27 is supplied to the load bank controller 17, to operator interface 29, and to the generator output power transducer 21.

Generator active power output is calculated by power transducer 21 and the resulting signal on line 21B is supplied to logic circuits or program in load bank controller 17.

Operator interface 29 allows the operator to input generator load setpoint, typically in KW (as an example, a 75 kW setpoint is used), but otherwise through a recognizable control parameter and view real-time gen-set loads and data logged data and operating parameters. Electrical signals from the operator interface 29 are transmitted by wire to power load bank controller 17.

Exhaust gas temperature 32A is measured at the outlet of the resistance element housing 25A by thermocouple 32. Voltage produced by the thermocouple 32 is carried by wire as signal 32A to power load bank controller 17.

Programmable logic circuits or software in power load bank controller 17 determines the instantaneous status of process measurements and applies control voltage to individual high voltage switches in solid state switch array 19.

Power conducted by individual solid state switches in array 19 is delivered to the resistance element bank 25 through terminal block 23.

In operation, when the resistive heater elements 25 are activated ON, the exhaust gas from the engine-generator set 10, 12 cools off the active heater elements 25. As an example, the temperature at sensor 32 may be 300 degrees C. The maximum setpoint limit temperature may be 500 degrees C. when all resistive elements 25 are ON. In an optimal operational mode, the diesel is 55-75% loaded. A kW setpoint of 75 kW is preferable for this example.

Sometimes, “active power” is called “real power” or “true power” to account for the reactive power component, or is sometimes referred to as “apparent power.”

A diesel engine used to power a generator will normally produce exhaust gases at sufficient temperature when the gen-set is loaded at or near rated power output. When the gen-set is loaded at or near rated power output, the engine functions effectively.

However, when generator loads are insufficient, the diesel engine operates poorly and this poor operation can be sensed by exhaust flow at less-then optimal temperatures. Long term, this may lead to serious engine damage.

In the present invention, the use of proportional heater controls operating the load resistive heat bank, which turn ON and OFF independent load bank elements in the exhaust gas flow creates an on-demand call for more power from the gen-set, which in turn causes the engine in the gen-set to increase its mechanical load, thereby causing the engine to emit exhaust gas at increasingly higher temperatures and operate in an efficient engine range. Since the independent load bank elements, being resistive heaters are hot, the relatively cooler exhaust gas cools the independent load bank elements. The generator supplies power nearly directly to the load resistive heat bank, except for the proportional ON-OFF-independent power control signals supplied to the load resistive heat bank The diesel engine is motively coupled to an electrical generator. The proportional heater control operates a load resistive heat bank disposed upstream of engine. The load resistive heat bank is controlled by a power control signal.

In one embodiment, an exhaust gas temperature sensor upstream of the filter generates signals which signals are fed to a controller which in turn generates a proportional load bank control signal based upon the sensed temperature.

Since operators are more familiar with electrical load settings in KW, the system operator sets a KW load setpoint, which the control system monitors the active power on line 13 to keep the temperature at or in the proper engine function range (the temperature based upon load resistive heat bank activation and the exit temperature of the exhaust gas from the engine).

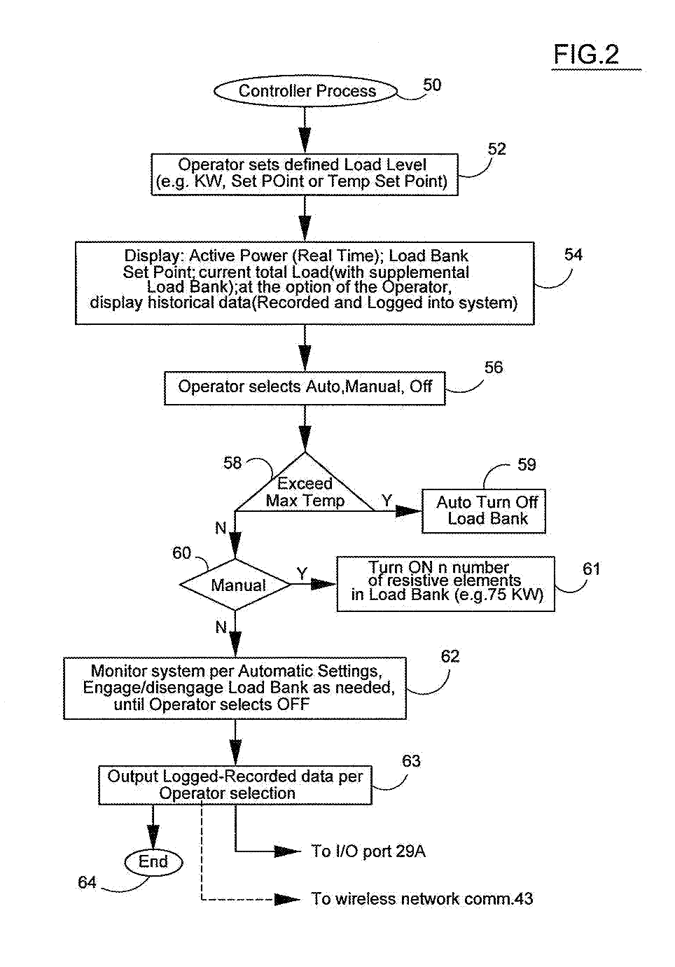

FIG. 2 diagrammatically illustrates a functional process flow chart showing the processes for the diesel electric generator load bank system cooled by exhaust gas method.

Controller process 50 begins at step 52 when the operator sets a defined load level for the gen-set 10, 12. For example, the operator may set a KW setpoint or a temperature setpoint. The temperature setpoint is based upon temperature signal 32A on exhaust line 26 leading to the exhaust port outlet to the environment.

In step 54, the operator user interface 29 displays the active power value, in real time, the load bank setpoint, the current total load on the system, with the supplemental resistive load bank, and, at the option of the operator, displays historical data. Historical data is recorded and logged into the system via memory 17B.

In step 56, the operator selects whether the system should be operating in the automatic maximum temperature, selects the GEN set KW output setpoint, or establishes other control parameters.

Decision step 58 determines whether the temperature signal 32A has exceeded the maximum level as set by limit module 34. If YES, the system, in step 59, automatically turns OFF the load bank

If NO, the system determines, in decision step 60, if the system operator has set the system to a “manual” mode. If YES, in step 61, the system turns ON a number “n” of resistive elements in the load bank, for example, 75 KW.

If the manual selection is not turned ON, the NO branch is taken from decision step 60 and, in step 62, the system monitors the operation of gen-set 10, 12 to achieve the automatic and optimal settings. This includes engaging or disengaging load bank elements 25 as needed until the operator selects OFF.

In step 63, the output of load bank controller 17 is stored and the other critical readings are stored, in a time-based manner, and are recorded first in memory 17B and then later in the memory of computer 41. The process ends in step 64. Outputs are provided via an output portals such as USB portal in interface 29A as well as outputs to the wireless communications network 43 or a LAN.

FIG. 3 diagrammatically illustrates an example of the user or system operator interface for the load bank controller (the user interface may be built-in or integral with the load bank controller or may be a separate unit).

Operator Interface 70 includes, as an example, and active power display 72 shown as a bar graph 72 which shows the active power in real time. In region 74, the operator selects the manual, automatic or OFF control modes. Historic logged data is provided at display region 76 and a display graph 78 shows the current active load over a 10 minute time line starting at the present “zero” time. Data is displayed in region 80 as indicated by user actuated controls from display-programmable menu region 82. Region 82 permits the user to input control commands and may be a keypad, a keyboard or touchscreen display. Programmable menu 82 includes options such as select kW, set maximum temperature (see Temp signal 32A in FIG. 1), select gen-set kW setpoint, and select gen-set kW total output.

Module 84 is an alarm indicator which, when activated, preferably is both an audio and a visual AV alarm when the temperature 32A exceeds a maximum as indicated by limit module 34. The alarm is also sent to remote computer-based units. The I/O port 29A (FIG. 1) has a number of USB ports, and potentially a serial port, and a parallel port and wired network port. Printers and other computer peripherals can be connected to the User Interface. For example, historic data can be copied from memory 17B to a thumb drive via a USB port in I/O 29A. In addition, input-output module 29A includes a wireless communications module 29B (FIG. 3) which permits communications over network 43 to remote computer or tablet computer 41.

Three-phase AC electrical power from generator 12, conditioned as a control signal by power transducer 21 is fed to the load bank controller 17. The power controller 17A feds controlled 3 phase power to switch array 19 which then delivers power to the exhaust heating elements 25. Array 19 is typically an SCR Power Controller. These SCR do not convert AC power to DC power. The SCRs switch the AC power to the heaters ON and OFF in proportion to a control signal from the load bank controller 17 in a variable time-based mode. For 50% power, the system supplies power ON for 3 cycles (for example) followed by an OFF period equivalent to 3 cycles. For 20% power, power is ON for 3 cycles and OFF for 12 cycles. The precision SCR electronics in array 19 eliminates the electrical noise associated with zero-cross switching the high voltages and currents at the zero-crossing of the AC power signals. As a result, the harmonics created by variable frequency controllers are eliminated. Power surges caused by switching heavy loads on and off as happens with conventional load banks and other electrically powered components are eliminated by the power control mode of the present system. Power supplied to the heater 25 is infinitely variable, it is smoothly applied or removed in proportion to system demand.

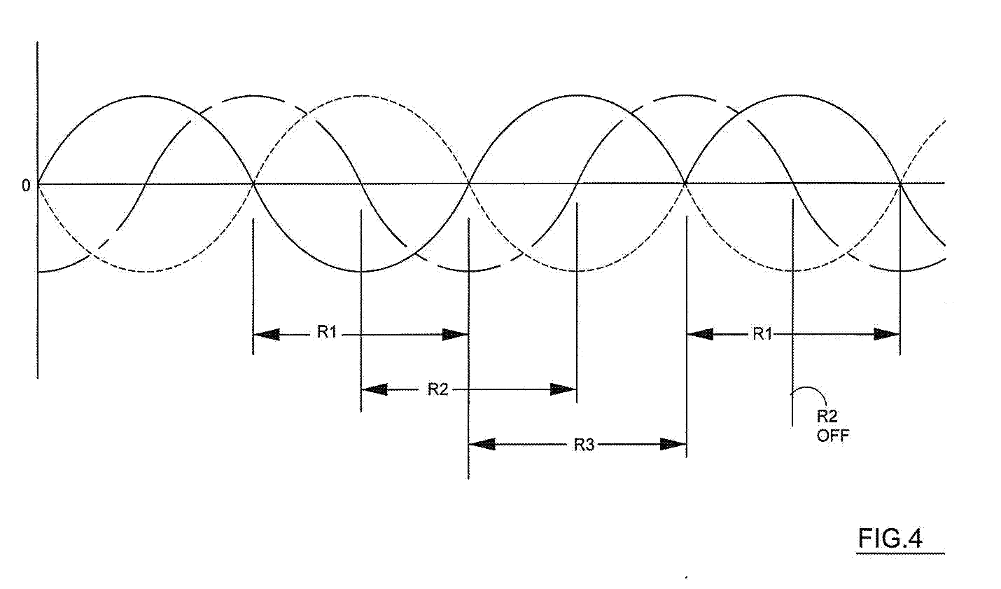

FIG. 4 diagrammatically shows switching at the zero-crossing for heater resistors R1, R2 and R3. Heater R2 is ON for one cycle then turned OFF for the second cycle (when R1 is ON for the second cycle). The Power Table below is an example wherein “-” represents an OFF cycle.

Power Table

| | Cycle 1-4 | Cycle 5-6 | Cycle 7-8 |
|---|---|---|---|
| Phase 1 | | | |
| high | R1 | — | — |
| low | — | — | — |
| Phase 2 | | | |
| high | R2 | R2 | — |
| low | — | — | — |
| Phase 3 | | | |
| high | R3 | — | R3 |
| low | — | — | — |

The exhaust gas temperature sensor can be disposed upstream of the heater. The controller generates the proportional heater control signal to maintain the exhaust gas temperature within a predetermined temperature range which includes the predetermined regeneration exhaust gas temperature. The heater is supplied power by the generator and the controller applies proportional power to the heater via one or more silicon controlled rectifiers (SCR) based upon the exhaust gas temperature. The SCR controlled heater reduces or substantially eliminates electromagnetic and radio frequency interference by the controller by switching AC power at the zero-crossing. Multiple temperature sensors may be used for better control of the heater and for safety alarm limit detection.

In the drawings, and sometimes in the specification, reference is made to certain abbreviations. The following Abbreviations Table provides a correspondence between the abbreviations and the item or feature.

Abbreviations Table

| | |
|---|---|
| alt | alternate or optional path or step |
| API | application program interface |
| AV | audio visual |
| bd | board |
| Bk | bank, as is load bank |
| Bkr | breaker, as in circuit breaker |
| btty | battery or other onboard power source |
| Cntlr | controller, as in load controller |
| comm. | communications, typically telecommunications |
| comp | computer |
| CPU | central processing unit |
| DB | data base |
| Displ | display |
| distrib | distribution, as in electrical distribution bus |
| drv | drive, e.g., computer hard drive |
| e.g. | for example |
| elec | electrical |
| equip | equipment |
| F or f | frequency |
| h-link | hyper link to a web page |
| htr | heater |
| I/O | input/output |
| id | identify |
| kyPd | keypad or touch screen display acting as a keypad |
| kyBd | keyboard or a touch screen display function |
| mem | memory |
| mod | module, unit or sub-system |
| ntwk | network, namely a telecomm network, typically internet based |
| | network. A local area network is also possible. |
| obj | object, for example, a data object |
| Oper | Operator, such as a system operator |
| opt | optional or alternative program or module |
| pgm | program |
| proc | processor, typically a microprocessor |
| pwr | power |
| rcd | database record |
| rcd'd | logged ro recorded, typically into a database |
| re | regarding or relating to |
| rel | release |
| RQT | request |
| rev | review |
| Rpt | Report |
| rt | real time, may include day and time stamp data |
| sel | select |
| sen | sensor |
| sig | signal |
| sig cond | signal conditioner |
| spkr | speaker or audio announcement device |
| St. Sw. | state switch, as in solid state switch array |
| sys | system |
| Sys Op | System Operator |
| t | time |
| tbl't | tablet computer |
| telecom | telecommunications system or network |
| Temp | temperature |
| trdr | transducer, sometimes a transducer-sensor |
| txr | transmitter - receiver device, maybe BLUETOOTH (tm), lan, |
| | wireless telecom network, or radio frequency |
| w/ | with |
| w/in | within |
| w/out | without |
| wrt | with respect to |

### Description of Typical System Features

The system described above has a load bank controller which is a computer-enabled control device which interacts with a user interface and can interact with a remote computer-based device (tablet computer, laptop, iPad (tm), etc.). Computer tablets and other electronic devices may be configured in this manner. The system may use an App and an internet portal which permits the person to access the system.

The present invention relates processes data via computer systems, over the Internet and/or on a computer network (LAN or WAN, wireless, Bluetooth (tm)), and computer programs, computer modules and information processing systems to accomplish this load control.

It is important to know that the embodiments illustrated herein and described herein below are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art. Further, the program, or components or modules thereof, may be downloaded from the Internet of otherwise through a computer network.

The invention is not limited to any particular computer program or logic or language, or instruction but maybe practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

Those of skill in the art will appreciate that the various illustrative modules, components, engines, and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules, components, engines, and method steps described in connection with the embodiments disclosed herein can be implemented or performed with hardware such as a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor is hardware and can be a microprocessor, but in the alternative, the processor can be any hardware processor or controller, microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm and the functionality of a component, engine, or module described in connection with the embodiments disclosed herein can be embodied directly in hardware, in software executed by a processor, or in a combination of the two. Software can reside in computer or controller accessible computer-readable storage media including RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

What is claimed is:

1. A method of cooling load bank resistive elements acting as a diesel engine electric generator load bank, wherein said electric generator generates three phase AC power comprising:
providing a diesel engine driving an electric generator as a gen-set;
porting exhaust gas flow from the diesel engine to an exterior environment;
providing a plurality of resistive heater load elements in the exhaust gas flow before expelling the gas into the environment;
monitoring exhaust gas temperature in the exhaust gas flow before expelling the gas into the environment and either before or after said plurality of resistive heater load elements;
increasing the electrical load on the gen-set by activating ON said plurality of resistive heater load elements by three phase AC power applied thereto from said electric generator, thereby adding heat to the exhaust gas flow before expelling the gas into the environment;
said plurality of resistive heater load elements turned ON and OFF substantially only at zero-crossing times for the three phase AC power applied thereto, thereby substantially eliminating electrical interference noise from switching ON and OFF the plurality of resistive heater load elements; and
cooling the plurality of resistive heater load elements with said exhaust gas flow from the diesel engine and maintaining a preprogrammed setpoint for the operation of the gen-set.

2. A method of cooling load bank resistive elements as claimed in claim 1 wherein at least three resistance load elements, each supplied with a distinct phase of said three phase AC power, and each switched ON and OFF.

3. A method of cooling load bank resistive elements as claimed in claim 1 wherein said plurality of resistance load elements are a plurality of load step resistors.

4. A method of cooling load bank resistive elements as claimed in claim 1 including remotely controlling and changing said setpoint for the operation of the gen-set.

5. A method of cooling load bank resistive elements as claimed in claim 1 including step-wise increasing electrical load on the gen-set by activating ON one or more of the plurality of resistive heater load elements at substantially the zero-crossing of the three phase AC power over a predetermined number of three phase AC power cycles and turning OFF said one or more of the plurality of resistive heater load elements at another predetermined number of three phase AC power cycles while substantially maintaining said preprogrammed setpoint for the operation of the gen-set.

6. A method of cooling load bank resistive elements as claimed in claim 1 including displaying realtime operating parameters for the gen-set and electrical output and the exhaust gas temperature before expelling the gas into the environment, and storing the same in memory for later retrieval.

7. A diesel engine driven electric generator with a load bank cooled by exhaust gas comprising:
a diesel engine driving an electric generator as a gen-set, said electric generator generating three phase AC power;
an exhaust pipe which is ports exhaust gas flow from the diesel engine to an exterior environment;
a plurality of resistive heater load elements disposed in the exhaust pipe's exhaust gas flow before porting said exhaust gas into the environment, said plurality of resistive heater load elements supplied with said three phase AC power and turned ON and OFF substantially at the zero-crossing of the three phase AC power such that electrical interference noise from switching ON and OFF the plurality of resistive heater load elements is substantially eliminated;
an exhaust gas temperature sensor in said exhaust pipe to monitor exhaust gas flow temperature either upstream or downstream of the plurality of resistive load elements but before porting said gas into the environment;
a controller operatively maintaining a preprogrammed power output setpoint for the operation of the gen-set;
said controller coupled to said plurality of resistive load elements and to said exhaust gas temperature sensor;
said controller increasing an electrical load on the gen-set by activating ON one or more of the plurality of resistive load elements, thereby adding heat to the exhaust gas flow before porting the exhaust gas into the environment;
whereby said plurality of resistive load elements are cooled by exhaust gas flow from the diesel engine.

8. A diesel engine gen-set with a load bank cooled by exhaust gas as claimed in claim 7 wherein said plurality of resistance load elements are load step resistors.

9. A diesel engine gen-set with a load bank cooled by exhaust gas as claimed in claim 7 wherein said controller is a local controller for the plurality of resistive load elements, and including a remote controller for changing said setpoint for the operation of the gen-set.

10. A diesel engine gen-set with a load bank cooled by exhaust gas as claimed in claim 7 including a memory unit, coupled to said controller, for storing data representing operating parameters for the gen-set, electrical output and the sensed exhaust gas temperature.

11. A diesel engine gen-set with a load bank cooled by exhaust gas as claimed in claim 10 including a display for displaying realtime operating parameters for the gen-set and the electrical output and the sensed exhaust gas temperature.
